(19) United States
(12) Patent Application Publication
(10) Pub. No.: US 2004/0154460 A1
(43) Pub. Date: Aug. 12, 2004

(54) Method and apparatus for enabling music error recovery over lossy channels

(75) Inventors: Jussi Virolainen, Espoo (FI); Pauli Laine, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/359,809

(22) Filed: Feb. 7, 2003

(51) Int. Cl. G10H 7/00

(52) U.S. Cl. 84/645

(57) ABSTRACT

A method and a system are disclosed that transmit MIDI messages between a transmitter and a receiver through a link that is susceptible to errors. The method includes: detecting an error condition during the reception of MIDI messages from the link; estimating a severity of the error condition and, based on the estimated severity, selectively one of ignoring the error condition or substituting error concealment MIDI messages to compensate for the error condition. The error concealment MIDI messages may be received from the transmitter and stored in the receiver, or they may be generated algorithmically by the receiver. The method further includes determining a duration of the error condition, and if the duration exceeds some threshold, at the end of the error condition the receiver re-starts the use of transmitted MIDI messages at the beginning of a next bar, or at some other suitable location.

### TECHNICAL FIELD

These teachings relate generally to wireless communications systems and methods and, more particularly, relate to Musical Instrument Digital Interface (MIDI) data and messages, and to techniques for transmitting MIDI data and messages between devices through a wireless communications channel, such as a radio frequency (RF) or an optical (e.g., infrared (IR)) communications channel.

### BACKGROUND OF THE INVENTION

The information exchanged between two MIDI devices is musical in nature. MIDI information informs a music synthesizer, in a most basic mode, when to start and stop playing a specific note. Other information includes the volume and modulation of the note, if any. MIDI information can also be more hardware specific. It can inform a synthesizer to change sounds, master volume, modulation devices, and how to receive information. In more advanced uses, MIDI information can be used to indicate the starting and stopping points of a song or the metric position within a song. More recent applications include using the interface between computers and synthesizers to edit and store sound information for the synthesizer on the computer.

Modem mobile communication systems provide radio transmission technologies such as Bluetooth (low power, short range RF communications) that enable applications in different devices to easily communicate with each other. An important requirement for data transmission is the reliability, while latency is not a critical feature, whereas for speech transmission a short latency and a constant jitter variance are the most important parameters, while the reliability is typically not as critical.

However, a short latency (interactivity), small jitter variance and high reliability are all important and desirable features for MIDI transmission. These requirements can be contradictory when over-the-air transmission is used, especially when the quality of the radio channel is low. When the channel quality degrades the error rate increases, causing the effective transmission bandwidth to decrease. If an unreliable transmission protocol is being used then MIDI messages can be corrupted or lost, which is normally unacceptable. On the other hand, if a reliable transmission protocol is being used the latency will tend to increase because of re-transmissions that may render useless a time critical musical communication.

Real-time musical applications such as jamming (group playing) systems require a high degree of reliability as well as a small transmission latency in the data transmission system. These often-times conflicting goals may need to be realized by using a more unreliable (but low latency) transmission protocol, such as the User Datagram Protocol (UDP) or the Real-Time Transport Protocol (RTP), as opposed to a more reliable (but higher latency) transmission protocol. One potential target network for real-time jamming systems is one based on Bluetooth, or a packet network such as an Internet Protocol (IP) network.

MIDI messages can be lost when they are transmitted over an error prone network connection. The loss of information can result from, for example, network congestion in a packet data network, or from distortions and interference in a radio frequency link. For example, if the operating distance between devices is exceeded in a Bluetooth network, this can cause distortions to the connection. One result of transmission errors in a jamming application is an objectionable silent interval in the music. The length of the silent interval depends on the type of error and on the application itself, but typical interval times can be from one note to several notes, or even for one or more bars. Because musical communication is very sensitive to transmission errors and the resulting interruptions, the susceptibility of the musical system to transmission errors has an influence on the quality and usability of the system.

There are several interrelated influences of errors during a jamming session. Firstly, the players can lose the beat of the music, which is very annoying and typically has the potential to destroy the continuity of the group playing. Even when the error situation normalizes the players may not be able to quickly recover the beat, as the normalization can occur in any part of a measure or bar. Secondly, the players do not know what to play during the error situation. For example, they may not have knowledge of the harmony or the rhythm.

While the inventors are not currently aware of any conventional solutions that deal with music-oriented error concealment methods for musical parameters (e.g., MIDI), whenever transmission errors occur one could simply mute the output of the music synthesizer. For example, when errors in MIDI data are detected by a user's group playing application terminal, the output from the synthesizer can be muted. However, this results in the generation of an undesirable silent interval. Alternatively, and analogous to error concealment methods used for audio signals (such as during speech synthesis), a last correctly received bar or beat could simply be repeated, as opposed to muting the output of the synthesizer. However, this is not an optimum solution if one desires to maintain musical continuity.

With regard to an example of a system where a loss of messages has been taken into account, it is noted that a Network Musical Performance (NMP) occurs when a group of musicians, located at different physical locations, interact over a network to perform as they would if located in the same room. In this environment the significance of a lost Note Off message has been recognized, as evidenced in a publication entitled “A Case for Network Musical Performance”, J. Lazzaro and J. Wawrzynek, NOSSDAV'01, Jun. 25-26, 2001, Port Jefferson, N.Y., USA. These authors describe the use of a client/server architecture employing the IETF Real Time Protocol (RTP) to exchange audio streams by packet transmissions over a network. An RTP packet in the MIDI packetization scheme described by these authors includes a standard RTP header, including a sequence number and a timestamp, followed by a packet payload that contains a MIDI Command payload and a Recovery Journal. The Recovery Journal contains information that enables the receiver to recover from the loss of all RTP packets sent since an earlier RTP packet, referred to as a checkpoint packet. Appendix 1 of this publication describes the format of the Recovery Journal.

Also of interest, and related to the foregoing publication, is another publication: “The MIDI Wire Protocol Packetization (MWPP)”, also by J. Lazzaro and J. Wawrzynek, http://www.ietf.org/internet-drafts/draft-ietf-avt-mwpp-midi-rtp-05.txt, Internet Draft, Sep. 22, 2002 (expires Mar. 22, 2003).

The requirement to include the Recovery Journal in the packet payload can be a disadvantage when used in a bandwidth-constrained link, such as a wireless link. Further, the maintenance of the Recovery Journal can add to the overall system complexity.

In general, while the foregoing techniques may provide that an occurrence of a transmission error during a performance or during control of a MIDI device will not generate undesirable artifacts, such as the generation of hanging note in response to missing a Note Off event, the foregoing techniques may not be helpful if for example, a Note On event is lost during transmission.

In commonly assigned U.S. patent application Ser. No. 10/101,900, filed on Mar. 19, 2002, “Methods and Apparatus for Transmitting MIDI Data Over a Lossy Transmission Channel”, the present inventors describe techniques for transmitting MIDI data over an error prone network connection. This patent application is incorporated by reference herein in its entirety.

It is noted that in the GSM specification a mobile terminal is enabled to transmit additional data in the data stream for describing background noise parameters relevant to the transmitting terminal. These parameters are stored in the receiving terminal and are used during a discontinuous transmission mode of operation (DTX mode), when there is an absence of speech, to generate so-called “comfort noise” for the party at the receiving terminal. The party at the receiving terminal then hears noise that resembles the background noise at the transmitting terminal, and thereby avoids hearing periods of disconcerting complete silence when no speech-related data is transmitted. The comfort noise is not, however, used to conceal transmission errors, but is used instead to conserve power in the transmitting terminal, as transmissions may cease entirely or be reduced significantly when there is no speech, and while the other terminal is generating the comfort noise. Examples of the use of comfort noise and its generation can be found in the following exemplary commonly assigned U.S. Pat. No. 6,286,122 “Method and Apparatus for Transmitting DTX-Low State Information from Mobile Station to Base Station”, U.S. Pat. No. 6,269,331 “Transmission of Comfort Noise Parameters During Discontinuous Transmission” and U.S. Pat. No. 5,835,889, “Method and Apparatus for Detecting Hangover Periods in a TDMA Wireless Communication System using Discontinuous Transmission”.

### SUMMARY OF THE INVENTION

The foregoing and other problems are overcome by methods and apparatus in accordance with embodiments of this invention.

This invention provides both a method and an apparatus for using error recovery information in synthetic audio error recovery situations, i.e., this invention provides a technique for replacing corrupted musical information with side information.

This invention provides a technique that is usable with a number of MIDI transmission protocols, and can be employed as an application-specific method to improve the performance of an interactive musical application. The invention avoids the generation of a user-noticeable silent interval, when music is being played, because of transmission errors or network congestion.

The teachings of this invention apply to the transmission of both real-time and streamed MIDI data over a lossy channel. MIDI is a binary protocol that requires a perfect channel, and any errors that occur during transmission can result in different types of problems during MIDI playback, depending on the nature of the errors and where they occur. Further, real-time applications require low transmission delay (e.g., on the order of less that about 20 msec to about 40 msec) for musical playback, while non-real-time applications can tolerate larger transmission latency. The teachings of this invention provide error concealment methods for transmission errors that are not recoverable using conventional means.

This invention introduces and exploits a concept of a conditional musical pattern for error concealment purposes. An important, but non-limiting application of this invention is in a multi-terminal environment wherein the terminals are communicating wirelessly, such as via a low power, short range RF (e.g., Bluetooth) technique, or via an infrared (IR) technique.

A method and a system are disclosed that transmit MIDI messages between a transmitter and a receiver through a link that is susceptible to errors. The method includes: detecting an error condition during the reception of MIDI messages from the link; estimating a severity of the error condition and, based on the estimated severity, selectively one of ignoring the error condition or substituting error concealment MIDI messages to compensate for the error condition. The error concealment MIDI messages may be received from the transmitter and stored in the receiver, or they may be generated algorithmically by the receiver. The method further includes determining a duration of the error condition, and if the duration exceeds some threshold, at the end of the error condition the receiver re-starts the use of transmitted MIDI messages at an appropriate time, such as at the beginning of a next bar.

The MIDI messages can be received during the transmission of streamed MIDI messages, or during the transmission of MIDI messages associated with a (real-time) group playing session.

The link can be or can include a wireless link. As an example, the method is executed by a mobile terminal, and the link includes a radio frequency link, such as a low power, short range radio frequency link. The link can be implemented in whole or in part by a packet data network. The link may be embodied as a bi-directional radio frequency link that provides an indication from the receiver to the transmitter of the reception of the error concealment MIDI messages.

The step of detecting the error condition may include monitoring a plurality of active sensing signals having a temporal resolution that is a function of the timing of the music conveyed by the MIDI messages. In this case the step of estimating the severity of the error condition may include determining a number of missing active sensing signals.

The error concealment MIDI messages can represent an error recovery musical pattern that is sent in units to the receiver in, for example, a dedicated error concealment channel, or in a normal MIDI channel. In one embodiment the error concealment MIDI messages are transmitted to the receiver using MIDI note-on messages having a velocity set to zero.

The step of substituting can include transforming a key of music represented by the error concealment MIDI to a key of the music conveyed by the MIDI messages.

### BRIEF DESCRIPTION OF THE DRAWINGS

The above set forth and other features of these teachings are made more apparent in the ensuing Detailed Description of the Preferred Embodiments when read in conjunction with the attached Drawings, wherein:

FIG. 1 is a high level block diagram showing a wireless communication network comprised of a plurality of MIDI devices, such as one or more mobile stations and one or more MIDI units, such as a group playing or jamming session control unit or server;

FIG. 2 illustrates two MIDI music tracks and the use of a recovery track in accordance with this invention;

FIG. 3 is a block diagram of a MIDI device architecture suitable for implementing a Musical Error Recovery for Data Over Lossy Channels (MELOS) system in accordance with this invention, where the MELOS functionality is assumed as a non-limiting example to be embodied in an error concealment unit of one or more of the mobile stations shown in FIG. 1; and

FIG. 4 illustrates a logical flow diagram in accordance with a method of this invention.

### DETAILED DESCRIPTION OF THE PREFERRED EMBODIMENTS

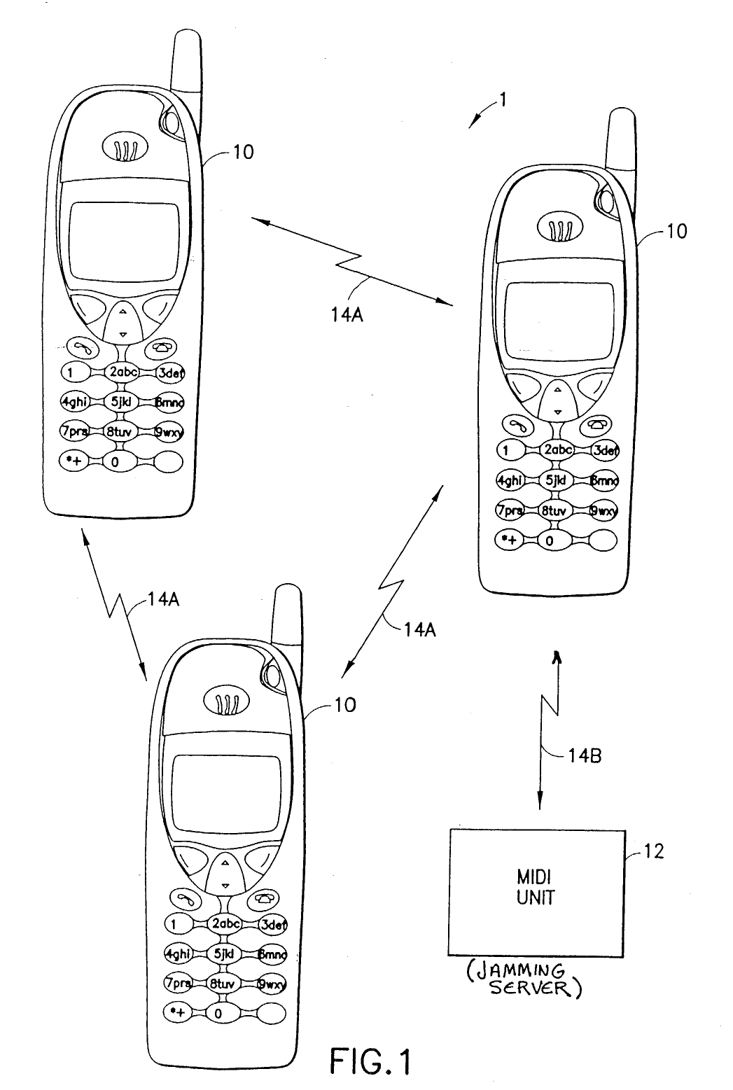

FIG. 1 shows a wireless communication network 1 that includes a plurality of MIDI devices, such as one or more mobile stations 10 and one or MIDI units 12. The MIDI unit 12 could be or could contain a music synthesizer, a computer, or any device that has MIDI capability. The mobile stations 10 could include headphones (not shown), or an internal speaker may be used for playing synthesized music. Wireless links 14 are assumed to exist between the MIDI devices, and may include one or more bi-directional (two way) links 14A between the mobile stations 10 and one or more bi-directional links 14B with the MIDI unit 12. The MIDI unit 12 may be or include, in this embodiment, a jamming server having responsibility for the overall control and coordination of a jamming (group playing) session being conducted using the plurality of mobile stations 10. Note that one of the mobile stations 10 may function as the jamming server as well. The wireless links 14 could be low power RF links (e.g., those provided by Bluetooth hardware), or they could be IR links provided by suitable LEDs and corresponding detectors. The wireless links 14 are assumed to be non-perfect lossy links, and can be susceptible to errors in data transmission.

An aspect of this invention is to provide a musical error concealment method and apparatus for use during musical data transmission, preferably during MIDI transmission. When incoming MIDI data is lost, or is present but has been corrupted, or has arrived too late to be played at the proper time, the error concealment method replaces generated silent intervals in the music with predetermined, artificial musically relevant data.

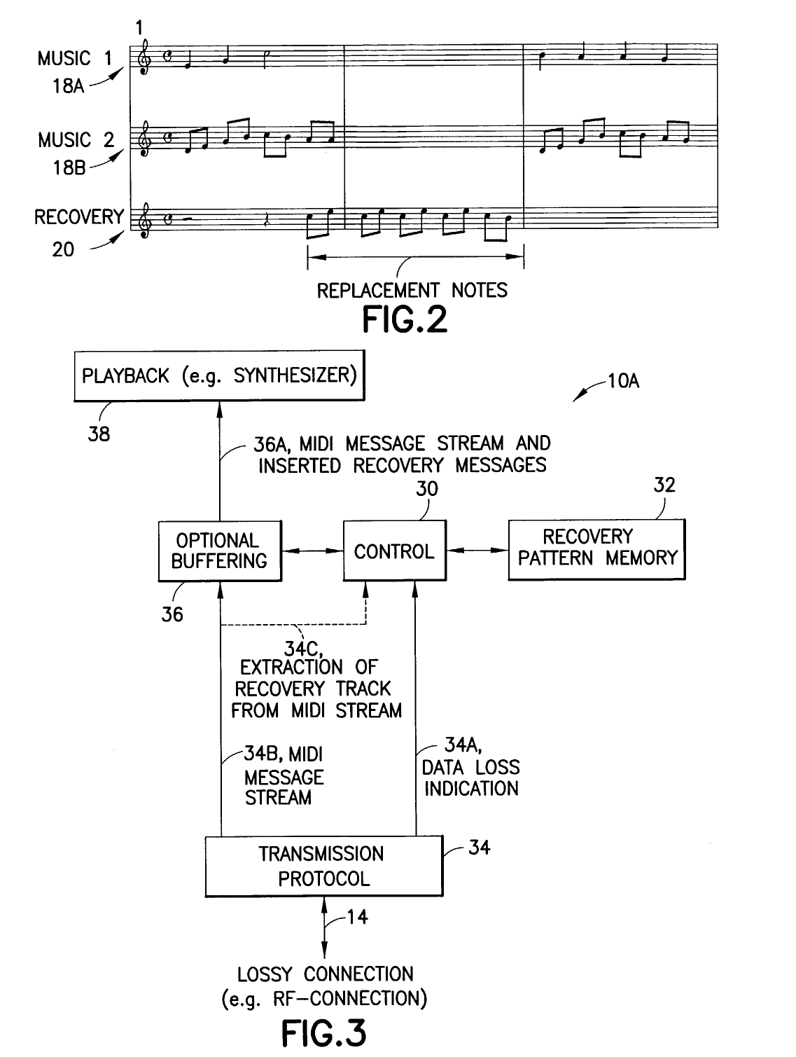

As can be seen in FIG. 2, the loss of MIDI-messages is concealed by adding information to music tracks 18A and 18B from a “recovery track” 20. The recovery track 20 information is added to or supplements the MIDI data. The recovery track 20 serves to at least keep the user informed of the beat of the music. If the error-situation is short (such as for one or two beats or 8ths), lost notes can be simply replaced by the recovery track 20. If the error-situation is longer than a few beats, the lost notes are also replaced by the recovery track. In this case, however, when the error situation normalizes the original tracks 18A, 18B are delayed (or discarded) so that a leading break can be played. This informs the user to return to the normal playing mode.

Whenever the recovery track 20 is played, the user can be automatically be made aware of errors occurring in the transmission path. One suitable technique to emphasize the occurrence of the error situation employs some specific instrument to play the recovery track 20. For example, a user that is running a jamming application over a Bluetooth network becomes aware of errors occurring in the wireless channel and is enabled to take corrective action, such by changing his or her location in the room to achieve a better connection to the base station.

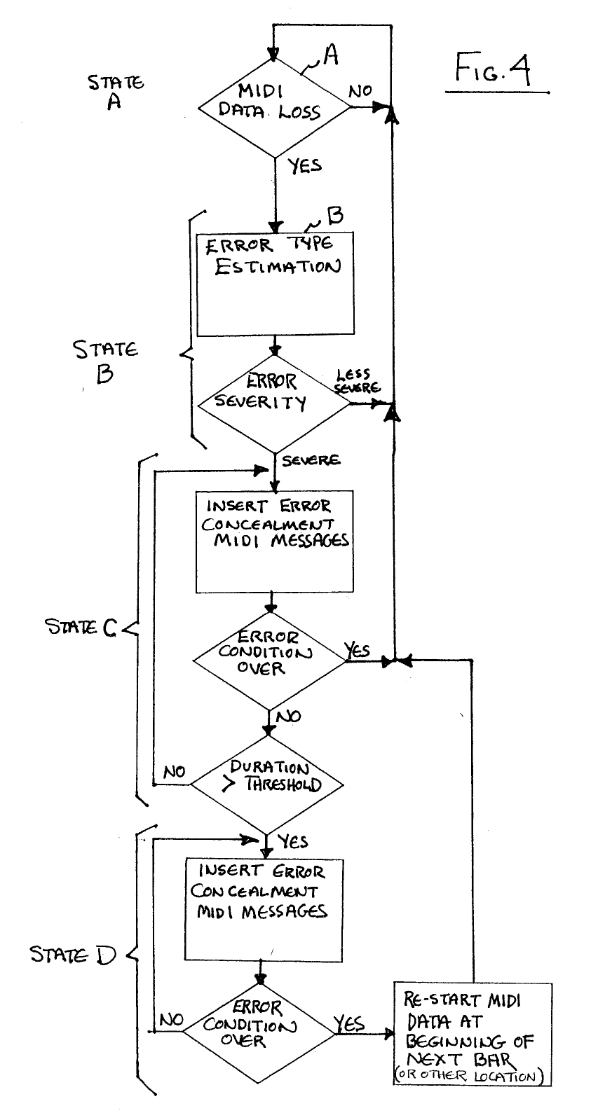

As employed herein the “recovery track” 20 implies the existence of a parallel data (secondary) channel between the sender and the receiver. During a MIDI transmission this connection can be implemented, for example, as an additional MIDI channel that is not played back under normal conditions by the MIDI receiver. Alternatively, the dynamic value of the notes in the recovery track can be set to “0”, so that even if it is played by the MIDI receiver the notes cannot be heard. The data in the recovery track 20 channel is used only if the primary MIDI data (tracks 18A, 18B) is lost during transmission. The recovery track 20 is used to transmit certain patterns from the sender to the receiver, where the receiver saves these patterns in a local memory, such as the pattern recovery memory 32 shown in FIG. 3 and described in further detail below. The length of a recovery pattern can be, for example, one bar.

In the example shown in FIG. 2, the recovery pattern is a simple percussion track, e.g., a “hihat track”. The musical notion conveyed by the recovery track 20 keeps the user informed of the beat, and may also signal the end of the error-situation.

The recovery pattern may be generated in the jamming server 14, which is assumed to have knowledge of the details of the music style which is being played. The jamming server 14 sends the recover patterns to the MIDI receivers, or mobile stations 12 in the example of FIG. 1, using the recovery track 20. The recovery pattern can be generated by a MIDI streaming server, such as by the jamming server 14, or alternatively the entire recovery track 20 can be stored in the server memory. The server 14 can change the recovery pattern as needed, e.g., when the time signature of the music is changed, when the music style is changed, when the key is changed, or in response to any other change in the music being played.

It is pointed out that the concept of a “track” in this invention need not correspond to the conventional MIDI file-related “track”. A “track” as employed herein may be considered to be analogous to a channel, and corresponds, typically, to one MIDI channel.

The receiver located in the mobile station 10 monitors the recovery track 20 and stores the recovery track patterns whenever they are available. These recovery track patterns are stored in a memory 32 of a transmission error concealment unit 10A of the mobile station 10, as described below in regard to FIG. 3. In a simple system, when a new recovery pattern is received the old pattern can be discarded. In more advanced systems several recovery patterns can be stored. They may be dedicated to different instrumental tracks, or they may be for the same track. As one non-limiting example, it is possible to send different drum fill patterns to the MIDI receiver, and the MIDI receiver selects the most suitable drum fill pattern to be used during error concealment processing. The selection of recovery patterns can be based on, for example, the similarity to an ongoing pattern, or the selection can be controlled by metadata that is sent via the MIDI stream. The receiver may be informed that the current playing style is ‘bossanova’, and when a recovery pattern is required a suitable pattern for the bossanova style is used (based on stored bossanova and other musical styles.

FIG. 3 is a block diagram of the MIDI device architecture suitable for implementing the Musical Error Recovery for Data Over Lossy Channels (MELOS) in accordance with this invention. In this embodiment the MELOS functionality is assumed to be embodied in the error concealment unit 10A of one or more of the mobile stations 12 shown in FIG. 1, although it can be embodied as well in the MIDI unit 14, and in any of a number of other types of MIDI devices and units whether communicating through wireless or wired links 14. It is assumed for this non-limiting embodiment that the transmission protocol 34 in effect (e.g., RTP or UDP) indicates (34A) when data is lost during transmission. A control unit 30 is responsible of estimating an occurrence of, or detecting the presence of the error situation and initiating the error concealment process. During the error concealment process the control unit 30 detects which tracks needs to be recovered and fetches the recovery information from the pattern recovery memory 32. Alternatively, the control unit 30 may generate the recovery data algorithmically. Transformations for a stored or an algorithmically generated recovery pattern may be needed in some cases. These transformations can include, but need not be limited to, transposition, augmentation, diminution and/or changes in particular notes before insertion into the MIDI data stream.

Further in this regard, when it is detected that MIDI events are missing from the incoming stream, a severity check is performed and, based on whether the missing event is deemed to have an adverse impact on the listener's experience, a recovery action is performed if needed. The control unit 30 may use pre-composed patterns, or it may use error recovery patterns that are received via MIDI stream. Recovery patterns are fetched from the memory 32. While a number of possible transformations may be implemented, and applied at various times and under different error conditions, a most basic example of a transformation involves transposing the error recovery pattern to the same key as that of the music being played. Note that this transformation is not required for percussion, but is desired for use with instruments having a detectable pitch. Key detection can be performed by analyzing the MIDI stream in real-time to detect the current key, or the key information can be retrieved from an optional higher level of musical information that can be transmitted between the transmitter and the receiver.

In practice, the MIDI message stream is preferably modified to include MIDI messages having inserted MIDI commands. These inserted MIDI commands can include Channel Voice messages, such as Note On, Note Off, Control Change, Program Change and Pitch Wheel Change, as well as Channel Mode Messages, System Common Messages and System Real-Time Messages. The inserted MIDI messages and commands compensate for the loss or corruption of the originally transmitted MIDI commands received from the link 14. The inserted MIDI commands can be generated based on the pre-stored error recovery track information from the pattern recovery memory 32, or they can be generated algorithmically, possibly based on some data stored in the memory 32.

In FIG. 3 it is shown that the recovery track 20 can be extracted from the MIDI message data stream 34B and stored in the pattern recovery memory 32. The operation of forming the extracted recovery track 34C is facilitated by including signaling in the MIDI message stream for identifying the recovery track MIDI messages and distinguishing them from the normal music program.

The recovery track may be a separate MIDI channel which is simply not played by the receiver. In this case the receiver is assumed to have knowledge of the MIDI channel number that contains the recovery track. In another embodiment the recovery track is normal channel, that is played as the other MIDI channels, but where the transmitter has set the velocity to zero in the MIDI note-on messages so that the played notes cannot be heard during streaming. When the control unit 30 extracts the pattern it sets some predetermined non-zero velocity values to the notes before saving the recovery pattern to the memory 32, thereby enabling the notes to be heard in the event that they are required to be played. A further, less preferred, embodiment uses a proprietary data channel for conveying the recovery track(s), but in this case portability can be impaired.

In one embodiment an active sensing signal is employed to detect if notes are missing from the incoming stream. The sensing signal may also specify the current beat of the measure, and thus may function as a synchronization mechanism. The sensing signal can be, as one example, a periodically transmitted pattern in its own channel. For example, if the time signature in the music being played is 4/4, the sensing signal, having a resolution of 1/16 note, may contain four 1/16 notes that are transmitted per each beat. In this case, in one bar 16 note-on events are transmitted. Each note-on event may have a different pitch value. For example, zero may imply the first beat in the bar, and the following 1/16 notes during the same beat would have values of 1,2,3, . . . , 15. Using this approach, if one or more of the active sensing note-on events are missing, the control unit 30 is enabled to determine exactly in what part of the current bar the missing notes belong. In this arrangement, when note-on events from the sensing signal are missing the control unit 30 can determine that some other MIDI messages may be missing as well, and can then decide whether to use a recovery pattern to fill the gaps in the received MIDI stream.

Additional levels of hierarchy can be added to the error sensing system as well. For example, instead of indicating the missing notes only on each bar, groups of bars may be indicated. As a non-limiting example, if the values 0-15 are used for the first bar, the second bar may have the values 16-31, the third bar the values 32-47, and the fourth bar the values 48-63. In this case the receiver can indicate from which of the four bars the note or notes are missing, and in which part of each bar. In this approach a knowledge of higher level musical structures can be used in the error correction process. For example, different recovery patterns may be used for different bars in the illustrated four bar group. A more complex hierarchy may be possible to implement as well.

It should be noted that the sensing signal messages and the MIDI messages are preferably transmitted by the transmission protocol in such a manner that missing sensing messages indicate that MIDI messages are missing. One example of this is a typical case where data is transmitted in packets, and both MIDI messages and corresponding sensing signal messages are inserted into the same packets. As an example, this type of implementation can be realized when using UDP or RTP.

The foregoing sensing mechanism is somewhat analogous to the active sensing feature used in MIDI synthesizers. In this case special sensing messages are sent with a low frequency, such as about once per second, via the MIDI connection so as to check to see that the MIDI cable is still connected and operating properly.

The recovery pattern is sent to the receiver in such a manner that any possible confusion is avoided when the receiver detects boundaries where one recovery pattern starts and another ends. One approach is to asynchronously send the recovery pattern in sections to the receiver. In this case the minimum length of a section can be, for example, one bar. When a MIDI event is received from the recovery channel, that control unit 30 knows that this is the first note in the recovery pattern section, and that there will be other incoming MIDI events of at least one bar in duration. If a bar starts with a break, a note-on message with zero velocity is sent, thereby guaranteeing that bars fully filled with notes are sent to the receiver. When the recovery pattern segment has been sent, and no other MIDI events are forthcoming, the control unit 30 may enter a time out state with the knowledge that a full error recovery pattern has been received, and the recovery pattern can then be stored in the recovery pattern memory 32. In another embodiment the length of a recovery pattern segment can be a multiple of whole bars, so that recovery patterns of length greater than one can be sent as well. If the above described active sensing signal is used, the recovery pattern segments may be sent synchronously rather than asynchronously.

The data in the recovery channel can be used to replace the missing data in any arbitrary channel. Therefore it is desirable that the data in the recovery channel can be “directed” to some other channel. For example, if the muted recovery channel is channel number 15, and the recovery data is meant to be used as percussion (channel 10), an output_channel_variable can be used to denote the intended output channel. A MIDI Control Change message can be used to convey to the control unit 30 the value of the output_channel_variable.

There is a possibility that the recovery pattern itself is corrupted during transmission. If the active sensing signal is used this can be readily detected, and the impaired recovery pattern can be discarded by the control unit 30. Alternatively, the recovery patterns may be sent asynchronously in a reliable manner, e.g., by using the technique described in the above-referenced U.S. patent application Ser. No. 10/101,900, filed on Mar. 19, 2002. In this case synchronization using active sensing is preferably not used, as the active sensing is most likely time-critical, and may be sent in an unreliable manner. In this case the data sent in a reliable manner will not be in synchronization with the data sent in an unreliable manner if a retransmission occurs.

The foregoing approaches may be employed in the server by the control unit 30 as well, when the output is not sent to the synthesizer 38 directly, but over a network (possibly a lossy network) to one or several clients.

In the preferred embodiment the control unit 30 inserts the recovery pattern or messages into the MIDI message stream 36A before it is forwarded, via optional buffer 36, to the MIDI-enabled music synthesizer 38. The optional buffer 36 can be used by the control unit 30 to store previous data that maybe needed when certain types of advanced musical error concealment algorithms are employed. In the simplest form of error concealment the previous data is simply repeated in patterns of some duration, much like repetition in music. It is also within the scope of this invention to use only some part of the collected data, such as the pitch or the rhythm, in the error correction pattern.

Referring to FIG. 4, the following sequence of operations can be employed to realize the functionality of the error concealment process for musical parameters. A Monitoring State designated “A” operates to detect a loss of MIDI messages from the link 14. This can be achieved by monitoring the data loss indication signal line 34A which reflects if a packet or other type of data loss is detected by the transmission protocol 34.

If a MIDI data loss is detected, control passes to an Error Type Estimation State designated as “B”. In this case the control unit 30 of the error concealment unit 10A categorizes the grade or severity of the error and assigns a numeric or other type of grade to the error. As an example, and referring to the previous discussion of the active sensing signal, if some number, such as five, consecutive 1/16 notes are missing, then a determination is made that the error recovery action is warranted.

If the error is of the less severe nature (e.g., it may be un-noticeable to the listener), control passes back to State A, otherwise control passes to State C.

States “C” and “D” reflect the duration of the error state, with State C corresponding to a Short Error State and State D to a Long Error State. In the Short Error State, entered first, the controller 30 operates to insert MIDI messages into one or several tracks of MIDI message data using the data from the recovery pattern stored in memory 32. A test is periodically made to determine if the error condition exceeds some maximum threshold duration. If it does, control passes to State D to enter the Long Error State D. In this case the control unit 30 continues the error concealment process, but when correct MIDI data is received again from the link 14 the control unit 30 delays until an appropriate time, such as when a new bar begins, before terminating the insertion of the error concealment MIDI messages stored in the memory 32. The length of a bar can be calculated by the control unit 30 from the MIDI time signature, if available. If not, the length of a bar can be indicated in the recovery track 34C by the periodic insertion of a muted whole note.

The specific recovery pattern sent in the recovery track 34C may contain information that is derived algorithmically from the original music track. As non-limiting examples, the data of the recovery track 34C can convey information that is descriptive of the harmony of the original music track, the target chord or some melodic content, as well as any other parameters that can be used in the error concealment process. Higher level musical data may be transmitted as well. Examples include, but need to be limited to, pointers to musical building blocks (bars) or harmonic information (chords). The recovery track 34C may be a simple melodic line, or a plurality of melodic lines, and it may contain one or more separate tracks.

The foregoing method and apparatus, while well suited for real-time group playing applications, is also well suited for use with MIDI streaming applications.

The recovery track 34C can be employed in a number of different ways to provide the desired transmission error concealment process. For example, the recovery track 34C can be sent at the same time as and in parallel (redundancy) with the other musical data, although this technique is more susceptible to the occurrence of a loss of both the original music data and the recovery data. Alternatively, the recovery track 34C can be sent before the music track (e.g., Forward Error Correction or FEC), although this technique may be of lesser usefulness in real-time (e.g., group playing) musical applications. The recovery track 34C can also be implemented with a generalized correction bar or pattern that the control unit 30 saves in the memory 32, and may thus be pre-loaded prior to the start of the streamed or real-time music track(s). The recovery track 34C can also be generated locally at the receiver, such as by the control unit 30, by automatic music composition algorithms that use information derived from the original music. A non-limiting example of an automatic music composition algorithm is a stochastic algorithm, where the analyzed original data is used to adjust the parameters of the generative system. The Markov chain technique is particularly useful for generating music that is stylistically similar to the original music.

Various combinations of these features can also be implemented. As one example, the recovery track 34C is transmitted over the link 14 to the control unit 30, and the control unit 30 utilizes one or more automatic music composition algorithms that generate the error concealment pattern based on both the original music and on the recovery track 34C, such as by modifying a generalized correction bar in accordance with real-time characteristics of the music program.

In one embodiment of this invention the recovery track 34C is provided prior to the relevant MIDI data, such as one bar prior to the MIDI data. In this case the transmission error concealment unit 10A operates in the Forward Error Correction mode. The FEC mode is more applicable to streaming applications where all MIDI data to be streamed is available at the sender, and where the MIDI data can be buffered without causing any audible side effects for the listener. However, data to be streamed is typically buffered at the receiver side (e.g., in the mobile station 10). In this case the use of the error concealment process can be to avoid silent periods in the playback should the playback buffer (e.g., buffer 36) become empty because of network congestion and/or errors. When the correct MIDI data again arrives, the control unit 30 preferably discards some part of it that has already been substituted for by the error concealment MIDI messages (e.g., measured in bars), to avoid playing the same bars again. The playback begins again starts the when correct position is found in input MIDI data.

In another embodiment, what is being streamed to the receiver, e.g., to the mobile station 10) from some network server (such as the MIDI unit 12) contains both MIDI data and an audio signal(s). In this case, and when transmission errors occur, this invention can be used to assure that uninterrupted MIDI music is played, while the audio signal may become silent from time to time during long errors or during network congestion.

It should be apparent that the teachings of this invention are well-suited for use in real-time interactive music applications. These applications may use musical content that is specifically authored for use by the applications. In accordance with this invention the MIDI data is transmitted with additional information that is transmitted on a secondary recovery track. Typical MIDI music employs several music tracks for the same song, and there may be a separate recovery track for each music track, or a lesser number of recovery tracks than the music tracks. The recovery track information may be generated automatically by a computer, or a composer or arranger or editor of the music may compose the recovery track information. The automatic generation of the recovery track information, for a case where a variety of types and styles of musical pieces (musical content) are streamed over a lossy channel, can be facilitated if the content contains metadata information that is descriptive of the musical content.

A typical MIDI data rate is less than about 30 kbits/sec. As such, fast transmission protocols can send and resend packets several times to maintain MIDI latency requirements. In protocols that use retransmission there is preferably a limit on the number of re-transmissions so that the maximum transmission delay can be guaranteed.

As was noted above, a situation may occur where there is an error during the transmission of the recovery track 34C. If the sending unit is not aware of an occurrence of an unrecoverable transmission error during the transmission of the recovery track 34C, it does not have the information required to resend the recovery track. This may be addressed by providing a second logical transmission channel for the recovery information (making the link 14 bi-directional), if feasible in the target application. The secondary logical channel (the recovery channel) may rely on re-transmissions to ensure correct delivery of the recovery track 34C to the destination terminal. If the separate logical channel is not used, and if the transmission of the recovery track 34C fails for any reason, then if needed a previous recovery pattern may be re-used, or a default recovery pattern may be used, or the recovery pattern may be generated in situ by execution of a suitable algorithm or algorithms.

It is within the scope of this invention for the receiver (e.g., the mobile station 10) to perform the error concealment locally by monitoring the incoming musical information (e.g., a drum track) and then storing the beat pattern of one bar as a recovery pattern in the memory 32. This process can occur but once, or it can occur periodically, either on some fixed schedule or whenever there is a change in the track of interest (e.g., in the drum track in this case). Whenever a link error is detected, the controller 30 replaces the drum track with the recovery pattern from memory 32. As such, the external generation and transmission of the recovery track 34C is not required, as the recovery pattern is generated from the incoming MIDI track or tracks. This technique thus enables at least the beat of the music to continue during periods when the MIDI message stream is interrupted by transmission and/or network problems, and thus it may said that the beat goes on.

While these teachings have been particularly shown and described with respect to preferred embodiments thereof, it will be understood by those skilled in the art that changes in form and details may be made therein without departing from the scope of this invention.

What is claimed is:

1. A method of transmitting MIDI messages between a transmitter and a receiver through a link that is susceptible to errors, comprising:
detecting an error condition during the reception of MIDI messages from the link;
estimating a severity of the error condition; and
based on the estimated severity, selectively one of ignoring the error condition or substituting error concealment MIDI messages to compensate for the error condition.

2. A method as in claim 1, where the error concealment MIDI messages are received from the transmitter and stored in the receiver.

3. A method as in claim 1, where the error concealment MIDI messages are generated algorithmically by the receiver.

4. A method as in claim 1, further comprising determining a duration of the error condition, and if the duration exceeds some threshold, at the end of the error condition re-starting the use of transmitted MIDI messages at a suitable time.

5. A method as in claim 4, where at the end of the error condition the method restarts the use of transmitted MIDI messages at the beginning of a next bar.

6. A method as in claim 1, where the error concealment MIDI messages are received during the transmission of streamed MIDI messages.

7. A method as in claim 1, where the error concealment MIDI messages are received during the transmission of MIDI messages associated with a group playing session.

8. A method as in claim 1, where the link comprises a wireless link.

9. A method as in claim 1, where the method is executed by a mobile terminal, and where the link comprises a radio frequency link.

10. A method as in claim 1, where the method is executed by a mobile terminal, and where the link comprises a low power, short range radio frequency link.

11. A method as in claim 1, where the link is comprised of a packet data network.

12. A method as in claim 2, where the link is comprised of a bi-directional radio frequency link that provides an indication from the receiver to the transmitter of the reception of the error concealment MIDI messages.

13. A method as in claim 1, where detecting the error condition comprises monitoring a plurality of active sensing signals having a temporal resolution that is a function of the timing of the music conveyed by the MIDI messages.

14. A method as in claim 13, where estimating a severity of the error condition comprises determining a number of missing active sensing signals.

15. A method as in claim 1, where the error concealment MIDI messages comprise an error recovery musical pattern that is sent in units to the receiver.

16. A method as in claim 1, where the error concealment MIDI messages are transmitted to the receiver in a dedicated error concealment channel.

17. A method as in claim 1, where the error concealment MIDI messages are transmitted to the receiver using MIDI note-on messages having a velocity set to zero.

18. A method as in claim 1, where substituting error concealment MIDI messages comprises transforming a key of music represented by the error concealment MIDI to a key of the music conveyed by the MIDI messages.

19. A system for transmitting MIDI messages between a transmitter and a receiver through a link that is susceptible to errors, said receiver comprising a control unit for detecting an error condition during reception of MIDI messages from said link, for estimating a severity of said error condition and, based on said estimated severity, for selectively one of ignoring said error condition or substituting error concealment MIDI messages to compensate for said error condition.

20. A system as in claim 19, where said receiver further comprises a memory for storing said error concealment MIDI messages that are received from said transmitter.

21. A system as in claim 19, where said error concealment MIDI messages are generated algorithmically by said control unit.

22. A system as in claim 19, where said control unit further determines a duration of said error condition, and if said duration exceeds some threshold, at an end of said error condition said control unit re-starts the use of transmitted MIDI messages at a suitable time.

23. A system as in claim 22, where at the end of the error condition the system restarts the use of transmitted MIDI messages at the beginning of a next bar.

24. A system as in claim 19, where said error concealment MIDI messages are received during transmission of streamed MIDI messages.

25. A system as in claim 19, where said MIDI messages are received during transmission of MIDI messages associated with a group playing session.

26. A system as in claim 19, where said link comprises a wireless link.

27. A system as in claim 19, where said receiver comprises a mobile terminal, and where said link comprises a radio frequency link.

28. A system as in claim 19, where said receiver comprises a mobile terminal, and where said link comprises a low power, short range radio frequency link.

29. A system as in claim 19, where said link is comprised of a packet data network.

30. A system as in claim 19, where said link is comprised of a bi-directional radio frequency link that provides an indication from said receiver to said transmitter of reception of said error concealment MIDI messages.

31. A system as in claim 19, where said control unit, when detecting the error condition, monitors a plurality of active sensing signals having a temporal resolution that is a function of the timing of the music conveyed by the MIDI messages.

32. A system as in claim 31, where said control unit, when estimating a severity of the error condition, determines a number of missing active sensing signals.

33. A system as in claim 19, where the error concealment MIDI messages comprise an error recovery musical pattern that is sent in units to said receiver.

34. A system as in claim 19, where the error concealment MIDI messages are transmitted to said receiver in a dedicated error concealment channel.

35. A system as in claim 19, where the error concealment MIDI messages are transmitted to said receiver using MIDI note-on messages having a velocity set to zero.

36. A system as in claim 19, where substituting error concealment MIDI messages comprises transforming a key of music represented by the error concealment MIDI to a key of the music conveyed by the MIDI messages.
